(19) United States
(12) Patent Application Publication
(10) Pub. No.: US 2011/0156290 A1
(43) Pub. Date: Jun. 30, 2011

(54) Medium Orbital Flow Oxygenator

(76) Inventor: David Allen Wensloff, Oakhurst, CA (US)

(21) Appl. No.: 12/649,825

(22) Filed: Dec. 30, 2009

(51) Int. Cl. B01F 3/04

(52) U.S. Cl. 261/93

(57) ABSTRACT

An apparatus for oxygenating and mixing a body of liquid includes an impeller rotating about a vertical axis and driven by a submersible motor. The impeller is incased in a housing with intake ports for both oxygen and water. Ports are located around the circumference of the housing such that the oxygen infused water may exit the housing in a radial direction and be dispersed across the tank before the pockets of oxygen rise to the surface. The motor and impeller housing are mounted to a horizontally positioned plate which is suspended from a float by adjustable chains or cables allowing variance in the depth of submersion for use in lagoons. Alternatively the unit may be mounted to the bottom of a tank or basin in applications where permanent installation is feasible such as in tanks. Pure oxygen is supplied from a source outside the body of water and is of a purity level that allows highly efficient transfer of oxygen to the water receiving treatment. The invention disperses combined water and oxygen in the treatment basin for the purpose of dissolving oxygen in the water receiving treatment.

### REFERENCES CITED

1. Gross; Peter S. (Plymouth, Minn.), Slaymaker; Weselley E. (Minneapolis, Minn.) Lyco Manufacturing, Inc. (Columbus, Wi)
2. Ebner; Heinrich (Linz, AT), Golob; Karl (Bonn, Del.), Ditscheid; Konrad (Bonn, Del.)

U.S. Patent Documents

| | | |
|---|---|---|
| 5,762,833 | June 1988 | Gross, et al. |
| 5,458,816 | October 1995 | Ebner, et al. |

### BACKGROUND OF THE INVENTION

Aeration devices are used in the treatment of wastewater to infuse the water with ambient air. Such ambient air contains oxygen which is required by the wastewater to meet the bacterial oxygen demands of the biological processes that result in the breakdown of organic matter in water. Aeration processes typically rely on either mechanical or diffuser type aeration systems. Mechanical aerators produce movement in water which has the effect of exposing water to ambient air for transfer of oxygen while also mixing the liquid.

Diffuser type aeration injects oxygen into the water, most frequently from the ambient air, with a variety of injection methods available for the introduction of air beneath the surface of the water. This type of aeration system typically exposes the liquid to the oxygen for the duration of time required for injected oxygen to travel from the submerged diffuser level to the surface of the water. A number of devices combine the mechanical and diffuser concepts such that the water being treated is mixed in the process of receiving diffused oxygen.

### RELATED ART

A number of devices have been proposed for use in aeration of water basins in which the aereated water is ejected radially into the water from an impeller spinning about a vertical axis. These take on a basic form that includes a submersible motor attached to an impeller which forces air and water together before projecting the air and water radially into the water receiving treatment. Such devices generally rely on atmospheric air which is aspirated down a tube by the rotation of the impeller and drawn together with water in an aeration zone. This type of device is disclosed in U.S. Pat. Nos. 5,458,816; 5,762,833. Such devices are relatively useful in the treatment of wastewater as they both aerate and mix the water receiving treatment. The radial dispersion of the aerated liquid forces oxygen toward the extents of the tank in order to aerate a large area under the surface of the liquid receiving treatment. The oxygen then floats to the surface of the body of water and diffuses oxygen all along the way.

These devices are typical of submersible aerators which are lowered to the floor of a basin and operate by aspirating atmospheric air down a tube by creating an area of low pressure in the aeration zone. The air is forcibly combined with the fluid at the vanes of the impeller and directed radially from the aerator. Such designs have been successful in the process of aerating a liquid.

These devices, though useful are limited by the amount of oxygen in the atmosphere. As oxygen composes a minority of atmospheric gases, the water is being exposed to a small amount of oxygen in addition to the other gases composing the atmospheric air. The diffusion of oxygen is thus limited not only by the duration of submersion of air bubbles, but also by the composition of the atmospheric gas as approximately 80% of the gas being diffused is nitrogen in cases where atmospheric air is utilized for aeration.

### SUMMARY OF THE INVENTION

The present invention utilizes the addition of nearly pure oxygen to an aeration system in order the increase the transfer efficiencies of such systems. The invention is an apparatus for the aeration of contained wastewater. The apparatus utilizes tested techniques for the aeration of fluids while utilizing additional techniques to increase the efficiency of the transfer of oxygen to the water. The apparatus makes use of an impeller which rotates within a volute casing and directs oxygen infused water radially from the impeller through ports in the casing into the liquid receiving treatment. The impeller is driven by a submersible motor. The impeller is contained in a housing which is mounted to the motor and attached to a plate suspended in the body of water. The aerator is suspended by chains connected to a float such that it can be raised or lowered to achieve the desired depth in a body of fluid or alternatively mounted to the base of a tank or basin.

Oxygen at higher than 90% purity is supplied to the aerator and drawn along with wastewater into a low pressure zone created by the rotation of the impeller. The oxygen enters the impeller housing from a port in the top while the wastewater is drawn in from an opening in the bottom. The oxygen is forcibly combine with the fluid as both are drawn into the impeller, creating micro-bubbles which are accelerated by the rotating impeller and forced radially through ejection ports along the circumference of the housing.

Oxygen is supplied to the aerator from an oxygen generator located outside the body of water or alternatively, cryogenically stored oxygen which can be delivered to the site. The potential oxygen to be transferred in this way can be as much as five times the oxygen available in air drawn from the atmosphere. This allows for much greater transfer efficiencies than can be achieved by other methods, resulting in lower aeration energy costs.

### BRIEF DESCRIPTION OF THE DRAWING

The invention is hereinafter described with the following drawings in which:

FIG. 1 is a front view of the invention positioned in a lagoon or other large body of liquid;

FIG. 2 is an isometric view of the invention with a float included;

FIG. 3 is an isometric view of the aspirator motor and volute assembly;

FIG. 4 is an exploded view of the aspirator motor and volute assembly;

FIG. 5 is a bottom view of the volute assembly.

### DESCRIPTION OF PREFERRED EMBODIMENT

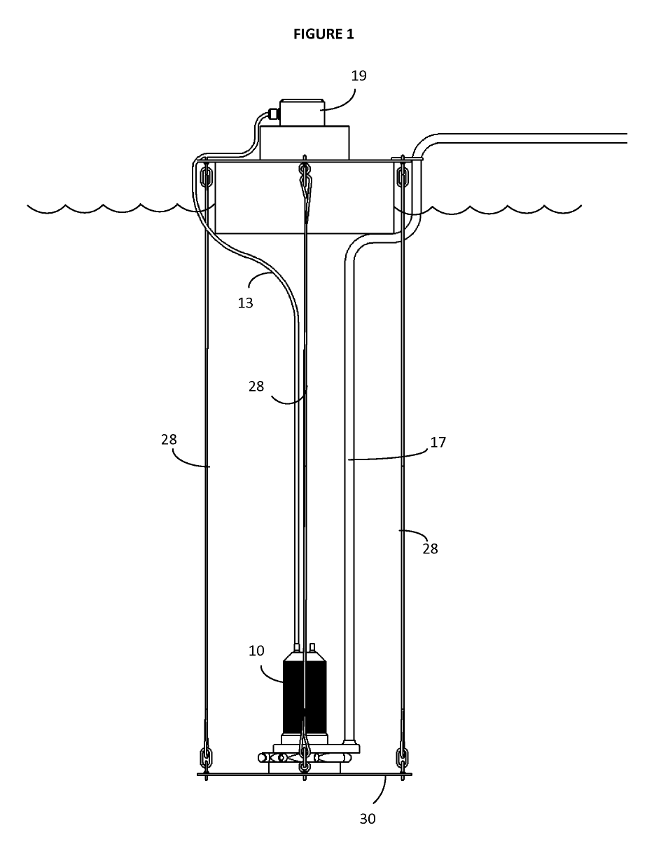

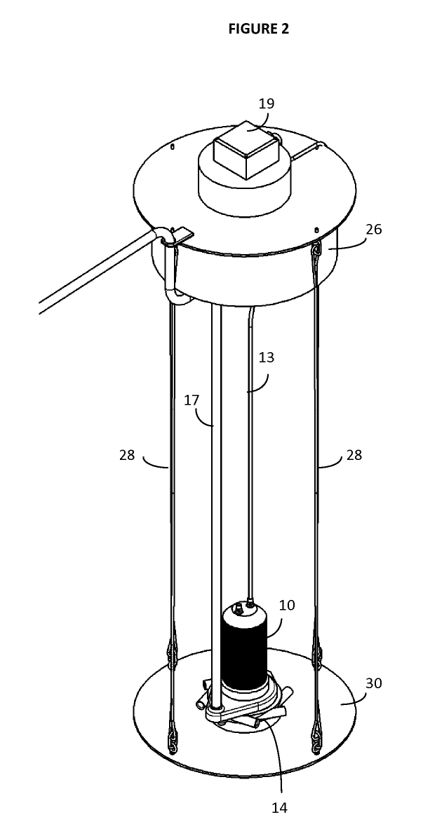

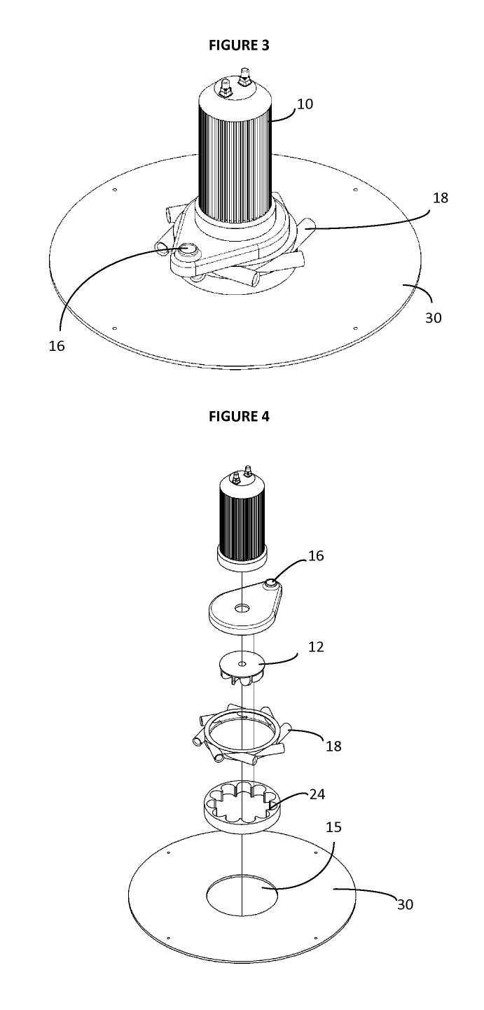

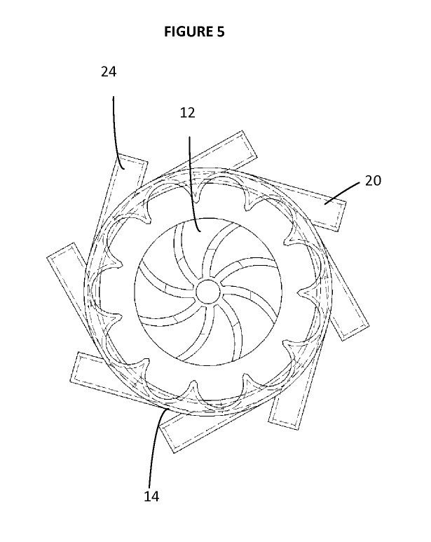

The preferred embodiment of the apparatus is represented in FIGS. 1-5 wherein like numbers refer to the components herein, a self aspirating orbital flow oxygenator.

The apparatus will be submerged in a body of water such as a pond, basin or large tank. The apparatus will be positioned near to the base of the body of water in order that aerated water may be forced into the body of liquid near the base. A submersible electric motor 10 is employed to drive an impeller 12 by means of a shaft in a specially designed housing 14 which acts as a volute casing. The rotational axis of the motor and impeller should be vertically aligned such that the impeller rotates in a horizontal plane. The impeller draws nearly pure oxygen from an oxygen inlet port 16 on the top side of the impeller housing. Wastewater is drawn in from a water inlet on the bottom of the volute casing 15. The oxygen and water are forcibly combined at the impeller where they are imparted with rotational energy from the impeller 12. The rotation of the impeller forms an area of low pressure such that oxygen is aspirated from down the inlet pipe and into the housing.

The submersible motor 10 will be supplied 3 phase AC electricity by water tight SEOOW cord 13 connected to an electrical connection box 19 mounted on top of the float, above the surface of the water for easy connection of the unit to a power source.

The oxygen is supplied to the inlet port 16 from a source of nearly pure oxygen delivered by an inlet pipe 17 from a flexible hose to a source outside the body of water receiving treatment. The rotation of the impeller within the housing creates an area of low pressure that aspirates oxygen down the piping and to the impeller. The use of nearly pure oxygen results in higher transfer efficiency than the conventional method of utilizing atmospheric air as an oxygen source. The oxygen may be supplied from one of a number of sources of nearly pure oxygen. The apparatus may be used in conjunction with an onsite oxygen generator utilizing absorption processes such as a VSA, PSA, VPSA or another oxygen generator which is capable of producing oxygen in the range of 90-95% purity. Alternatively, oxygen may be delivered from stored cryogenic liquid oxygen at very high purity levels. Such configurations are preferable to atmospheric gases, which have relatively low levels of oxygen and thus lower transfer efficiencies. The infusion of pure oxygen allows for much greater transfer of oxygen to the water. The system can be combined with an oxygen flow controller to provide control over the amount of oxygen transferred to the water in order to maximize the efficiency of oxygen use. The use of nearly pure oxygen allows a sustainable higher biomass in the aeration basin over conventional aeration. It high purity also allows the oxygen to dissolve effectively in a shallow basin.

A number of outlet ports 18 are positioned along the outer circumference of the volute casing. The ports employ cylindrical tubes extending tangentially from the volute casing to direct the water outward from the aspirator. The aerated wastewater is imparted with rotational energy from the rapid rotation of the impeller such that the fluid is forced from the casing through the outlet ports by means of centrifugal force. The aerated water is forced toward the extents of the basin of water as it is ejected from the device and the infused micro bubbles rise to the surface of the body of water, dissolving oxygen into the water at all points along the path.

One embodiment may utilize a volute casing having an array of cavities shaped as vertically aligned half cylinders 24 positioned around the inner circumference of the volute housing. This arrangement is utilized in order to increase the pressure to the aerated wastewater at the impeller. The cavities break up the flow of the water in the volute casing, forcing smaller eddy currents to form in each cavity. The close proximity of the impeller to the cavities in conjunction with the rapid rotation of the impeller generate increasing energy in the cavities with the passing of each successive vane of the impeller such that higher pressure may be achieved in the housing than would be with a volute casing shape that is parallel to the perimeter of the rotating impeller. This increased pressure enhances the formation of micro bubbles of oxygen and thus increases the effectiveness of the dissolution of oxygen in the wastewater.

In one embodiment a float 26 suspends the apparatus in the body of water. It is connected to a chain or cable 28 of adjustable length such that the depth of the apparatus may be altered as needed. A support plate 30 oriented in a horizontal plane is attached to the chain in order to suspend the unit at an appropriate depth for operation. Embodiments that make use of a float eliminate the need for mounting to the base of ponds where such mounting is infeasible. It further allows simple retrofitting as the apparatus can be easily positioned and repositioned in the pond or basin by altering the location of the float on the surface of the liquid. Alternatively, the apparatus may be mounted directly to the base of a tank or basin in applications where permanent position on a basin floor is feasible and desirable.

The apparatus enables an advantageous method for the dissolution of oxygen within a body of water. This apparatus benefits from the utilization of nearly pure oxygen in conjunction with a radial flow oxygenator. The purity of the oxygen enables high transfer efficiency rates resulting in lower aeration energy costs than conventional methods of aeration which rely on the oxygen dissolved from atmospheric air which contains very low percentages of oxygen. The radial flow ensures that the oxygen will be delivered to a large area within the body of water and will be dispersed effectively within that body. The unique shape of the volute casing further enhances the formation of micro bubbles which are important to the dissolution of oxygen within the water. Furthermore, the use of this apparatus allows the water to be mixed while it is being aerated and provides a method of aeration that can cover a large area without requiring a large footprint. The efficient aeration enabled by the apparatus makes it advantageous for use in many wastewater applications and superior in some applications to conventional aeration methods.

1. An apparatus for the aeration of a body of liquid comprising:
a. A submersible motor,
b. An impeller operatively connected to and positioned beneath said submersible motor,
c. A housing which encloses said impeller forming a volute casing with said housing attached attaches to said motor,
d. An oxygen inlet port positioned on top of said housing,
e. A plurality of volute ports located on the circumference of said housing and extending tangentially from said housing,
f. A plate oriented perpendicular to said submersible motor axis of rotation on which said motor and said housing are mounted,
g. a source of nearly pure oxygen positioned outside the body of liquid,
h. a conduit connecting said air inlet port on said housing with said oxygen source,
i. A means of power for said submersible motor.
j. A means of positioning said components within a body of water.

2. The apparatus of claim 1 wherein said oxygen source is an oxygen generator.

3. The apparatus of claim 1 wherein said oxygen source is stored liquid oxygen.

4. The apparatus of claim 1 wherein said means of positioning is one or more floats connected to said plate by means of suspension attached at a plurality of locations to said plate.

5. The apparatus of claim 4 wherein said means of suspension is a number of cables connecting said plate to said float.

6. The apparatus of claim 4 wherein the means of suspension is a number of chains connecting said plate to said float.

7. The apparatus of claim 1 wherein said means of suspension is anchors connecting said plate at to the base of said body of water.

8. The apparatus of claim 1 wherein said housing contains an array of cavities formed as vertically oriented half cylinders positioned about the inner circumference of said housing whereby eddy currents may be formed in the housing for greater oxygen dissolution.
